(19) United States
(12) Patent Application Publication
(10) Pub. No.: US 2011/0146390 A1
(43) Pub. Date: Jun. 23, 2011

(54) Process for Continuous On-Chip Flow Injection Analysis

(75) Inventors: Scott E. Gilbert, Seattle, WA (US); Mario Schlund, Aesch (CH)

(73) Assignee: CRYSTAL VISION MICROSYSTEMS LLC, Seattle, WA (US)

(21) Appl. No.: 13/026,612

(22) Filed: Feb. 14, 2011

Related U.S. Application Data
(62) Division of application No. 11/569,927, filed on Dec. 1, 2006.

(51) Int. Cl. G01N 1/00; F15D 1/00

(52) U.S. Cl. 73/61.59; 137/14

(57) ABSTRACT

A micro-fluidic method for continuous pressure-driven flow injection analysis and a planar microfluidic device intended for pressure driven flow injection analysis are provided. A network of microchannels allows a continuous flow of sample stream on the devices, as well as facile and reproducible analyte plug injection to a reagent or buffer stream on microchip-based devices. The method allows for sequent separation analysis without additional purging cycles.

### CROSS REFERENCE TO RELATED APPLICATIONS

This application is a divisional of co-pending U.S. application Ser. No. 11/569,927 which is the National Stage of International Application No. PCT/IB2004/001909, filed Jun. 4, 2004.

### BACKGROUND OF THE INVENTION

The present invention concerns a device and a process for on-chip flow analysis. More precisely, it concerns a planar microchip-based device, whereupon a network of microchannels is imparted to allow a flow of sample plug to analyses on the device. The invention is particularly adapted for field-portable chemical laboratories for environmental, military and civil protection uses, high-throughput drug discovery, proteomic analysis or medical diagnostics, and on-line process monitoring.

Demand for highly compact analytical chemical systems incorporating lab-on-chip microfluidic devices is beginning to gain momentum.

To this end, using a fully miniaturized and integrated approach, Tiggelaar et al., “Analysis systems for the detection of ammonia based on micromachined components: modular hybrid versus integrated monolithic approach”, Sensors and Actuators B, 92 (1-2) pp. 25-36 (2003), reported a flow injection analysis system where all fluidic components, including pumps and valves were microfabricated and assembled. The system was designed for sequential injection of analyte fluid into a continuously flowing reagent stream. Although this system proved to be technically feasible, the microfabrication procedures for the various components are very elaborate, excluding commercial production for low added-value applications due to the high costs involved. Moreover, the proposed solution was based on a complex control for creating sequential injection. These facts preclude for the time-being commercializable on-chip integration of valves and micropumps, for microfluidic devices.

In one approach to obtain pressure-driven microfluidic injection described by O'Neill et al., “On-chip definition of picolitre sample injection plugs for miniaturized liquid chromatography”, J. Chromatography A, 924 (2001) 259-263, a micromachined injection loop was integrated onto a planar liquid chromatographic chip, and an standard HPLC injection valve external to the chip was used to fill the micromachined loop. This method of injection rarely results in reproducible sample plug formation, since a delicate balance of static and dynamic pressures in the channel network are required to constrain the analyte to remain in the loop channel. In a microfluidic system, this balance is difficult to maintain when using external fluid handling equipment such as external pumps and valves.

An alternative to a fully integrated system is the realization of hybrid systems using passive microchips or microfluidic cartridges connected to external syringe pumps and switching valves, such as the system conceived by Bai et al. “Pressure pinched injection of nanolitre volumes in planar micro-analytical devices”, Lab-on-a-Chip, 2 (2002) 45-49 (see also Bai et al. “Finite element simulation of pinched flow injection in microchannels”, Anal. Chem. 74 (2002), 8203-8215, and U.S Patent Application Publication No. 2002/0130044 A1), have addressed the issue of pressure driven reproducibility. In this example, a well-defined injection plug is obtained by forcing a confluence of two opposed buffer streams and an orthogonal analyte stream at the intersection of sample and analytical channels in a cross configuration, using syringe pumps and a switching valve. The equipment external to the chip introduces significant dead volumes, that is, fluid volumes between the pumps or valves and the chip inlets. This solution is not adapted for on-line or real time measurement since the sample analysis is only possible after the long and not accurately predictable necessary time for purging the dead volume. Also, this solution introduces complexity to the operation of the device, where use is made of three independently controlled syringe pumps. Finally, reproducibility is difficult to achieve due to dead volumes associated with external tubing and valves, trapped air and elastic components in the external fluid path which are accountable for irreproducible behavior. This irreproducibility is manifest in varying injection sample volumes, leading to variations in the measurements. This leads to difficulties in performing several equivalent analyses, useful for validation purposes, for instance, what leads to a lack of reliability of the measurements.

A still further improvement of microfluidic sample injection was developed by Vahey et al., “Development of a positive pressure driven micro-fabricated liquid chromatographic analyzer through rapid-prototyping with poly(dimethylsiloxane)—Optimizing chromatographic efficiency with sub-nanoliter injections”, Talanta 51 (2000) 1205-1212. The latter citation is an example of a continuous flow injection system, but where external valves were used to control the injection sequence. This solution presents same disadvantages as the previous ones.

### SUMMARY OF THE INVENTION

A first object of the present invention is to provide a microfluidic device and process adapted for real-time and/or on-line fluid analysis.

A second object of the present invention is to provide a simple and inexpensive device and process.

A third object of the present invention is to provide a reliable device and process.

The device of the invention comprises an analyte fluid inlet means, a carrier fluid inlet means, where the two resulting analyte and carrier fluid inlet channels are disposed orthogonally and intersect, forming at this junction an injection cross, which is further extended by an analytical and a bypass channel that are respectively aligned with the analyte and carrier fluid inlet channels, and comprises a detector cell, the inlet means being continuous flow stream inlets, wherein flow resistances and injection cross are such that no analyte fluid flows in the analyte channel during a non analysis phase, and wherein the device comprises a means for momentarily modifying the flow conditions in at least one of the channels in order to create a sample plug of analyte fluid in the analyte channel.

The invention is better defined by the claims.

The invention also concerns the corresponding process, as claimed.

### BRIEF DESCRIPTION OF THE DRAWINGS

These objects will be apparent from the following description of specific embodiments, based on the following figures:

FIG. 1 represents the device in the non analysis phase;

FIG. 1a represents the whole device;

FIG. 1b represents the injection cross;

FIGS. 2, 3 and 4 represent the device for different steps of the analysis phase;

FIG. 2a represents the whole device at the starting step of the analysis phase;

FIG. 2b represents the injection cross area at the starting step of the analysis phase;

FIG. 3a represents the whole device just after creation of the sample plug of the analysis phase;

FIG. 3b represents the injection cross area just after creation of the sample plug of the analysis phase;

FIG. 4a represents the whole device at the analysis step; and

FIG. 4b represents the detector cell area at the analysis step.

### DETAILED DESCRIPTION OF THE INVENTION

In order to facilitate the following description of the present invention, specific terms are defined below.

The terms injection cross, intersection and junction are used interchangeably. These refer to the intersection of the inlet, analytical and bypass channels.

The terms run mode and standby phase are used interchangeably. These refer to the continuous operation of the device during which time no injection of analyte has occurred, and no injection plug is flowing in the channel network.

The terms injection mode and analysis phase are used interchangeably. These refer to the continuous operation of the device during which time an injection of analyte has been made, an injection plug is flowing in the channel network and detection cell.

The terms inlet means, inlet port, and outlet means, outlet port are used interchangeably.

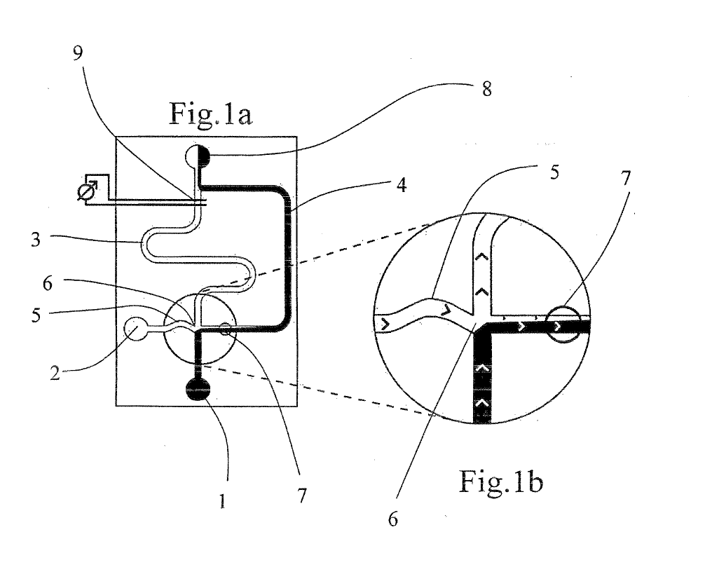

In the preferred embodiment of the invention, as illustrated by FIGS. 1 to 4, the microfluidic network is composed of inlet means 1 and 2 for analyte and carrier fluid, respectively. The two inlet branches are arranged orthogonally, and originate at inlet ports 1, 2 shown in the figures. Downstream of the ports, they share a common cross intersection 6, also referred to as the injection cross, intersection or junction, which communicates with analytical and bypass channels 3 and 4, respectively. In the region of injection cross 6, channels 3 and 4 are disposed orthogonally to each other. All microchannels and ancillary structures on the microfluidic chips described herein are produced using standard microfabrication techniques known to those skilled in the art.

Inlet means 1 and 2 receive the analyte and carrier liquids, respectively, in the form of flowing streams. The liquid streams are delivered to the inlet means 1 and 2 at hydrodynamic fluid pressures equal to or surpassing atmospheric pressure, thereby permitting control of the linear flow velocities of the liquids by regulation of said hydrodynamic fluid pressure at the inlets 1 and 2, and/or by regulating the sub-atmospheric pressure applied to the outlet 8 by a vacuum source. The continuous flow at inlet means 1 and 2 can be obtained by interfacing the chip to vessels containing analyte and carrier liquids by means of a chip interconnect manifold. The interconnect manifold is in turn connected to a pump for circulating analyte liquid in a sample loop external to the vessel containing analyte, which, in this instance, can be a chemical reaction vessel. By this example, reaction mixture comprising the analyte liquid is continuously refreshed and available for measurement, thus eliminating the need for purge cycles between measurements to clean the inlet lines with fresh solvent that would otherwise be necessary to avoid contamination by residue left from a previous sample. The liquids can also be supplied by static means of small volume liquid reservoirs positioned directly above and in fluidic communication with the inlet ports.

In the standby mode illustrated by FIG. 1, carrier fluid and analyte solution are allowed to flow continuously through the chip, where the latter is diverted into the bypass channel 4, and the former is forced to flow down the analyte channel 3. Due to the laminar nature of the liquid flow in the microchannels, a flow separation (see FIG. 1b) is created at the injection cross 6, thus preventing unwanted introduction of analyte into the analyte channel 3, since no mixing can occur at the confluence 6 of carrier and analyte streams.

In the preferred embodiment, substantially equal pressures are applied to the inlets. Prevention of adventitious introduction of analyte into the analyte channel 3 is assured particularly from a judicious choice of the respective lengths and therefore flow resistances of the analytical and bypass channels 3 and 4, where the flow resistance of the bypass channel 4 is chosen to be lower than that of the analyte channel 3, typically by a factor of two. The flow separation phenomenon and degree of flow is also influenced by other parameters such as fluid property like viscosity, geometry of inlet branches, cross section. The above described preferred embodiment could be adapted for specific values of these parameters for getting the passive natural adjustment of the flow ratio, illustrated in FIG. 1b. Finally, by simultaneous introduction of analyte and carrier streams by their respective inlet means 1 and 2, analyte spontaneously flows into the bypass channel. The majority of the carrier stream is subsequently constrained to divert its flow into the analytical channel since the hydrodynamic pressure of the analyte stream at the point of confluence, which occurs at the injection cross 6, is large enough to overcome the flow resistance of the latter channel. A small fraction of the carrier stream flows into the bypass channel 4, and its ratio to the total flow is regulated by the ratio of the latter's flow resistance to that of the analyte channel.

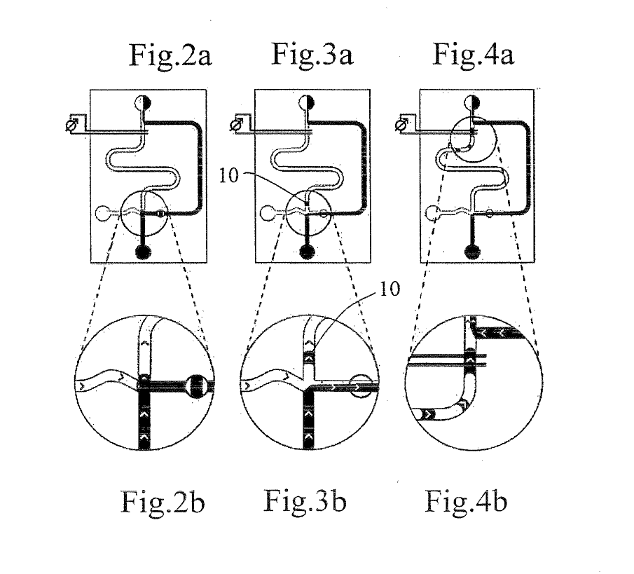

The analysis phase is based on the creation of a sample plug 10 of analyte fluid, flowing through the analyte channel 3. According to the concept of the invention, the sample plug 10 is created by a means 7 for momentary modifying the flow condition of at least one of the four channels. In the preferred embodiment, the sample plug 10 is created by significantly increasing the flow resistance of the bypass channel 4, at a point that can be anywhere along the bypass channel 4. Through this change of flow resistance, the analyte stream is momentarily diverted into the analyte channel 3, as illustrated in FIG. 2, and a well-defined sample plug 10 is generated, as illustrated in FIG. 3. The sample plug 10 size and form are defined by the length of time of the perturbation, and the geometrical form of the injection cross, respectively.

In the preferred embodiment, a rapid heating of the analyte in the bypass channel 4 is performed at point 7 by integrated resistive heating elements in order to create a vapor bubble. The bubble acts as an obstacle by forming a momentary blockage of the analyte flow before collapsing due to vapor condensation. As an alternative solution, the bubble can be generated using electrochemical methods.

As an alternative, the increase of flow resistance at point 7 along the bypass channel 4 can be obtained through pressing on the channel in the case of an elastic-body chip, e.g. one made from PDMS, or on rigid-body chips produced from silicon, glass or fused silica (quartz) wafer stock, or from thermoplastic polymers.

Another variation would be to momentarily lower the flow resistance in the analytical channel 3 to achieve the same effect.

In another alternative, an external pressure pulse can be applied to the carrier or analyte stream, also creating a momentary perturbation of the pressure balance at the inlet ports. The pressure pulse can be induced either by mechanical constriction of flexible tubing leading to the microchip fluid distribution manifold, or by a sudden rise pressure head in the reservoir containing the carrier or analyte fluid.

The curved channel segment 5 prior to the injection cross 6 optimizes the rear end of the sample plug 10 shape in order to obtain a nearly rectangular plug form.

The sample plug 10 is subsequently transported along the analytical channel 3 by the carrier fluid and passes through a detector cell 9 known from prior art, as illustrated in FIG. 4, in order to be analyzed.

Finally, the analyte channel 3 and the bypass channel rejoin at an intersection before the outlet point 8 of the microfluidic chip. In the preferred embodiment, both the analyte column 3 and the by-pass channel 4 are configured in a parallel way, the length of the latter being twice lower than the length of the former, in order to guaranty the above mentioned difference of flow resistance.

The above embodiment is advantageous because the inlet means are able to deliver fluid near the atmospheric pressure, and the fluid stream is generated by the use of an outlet vacuum, what leads to a stable, simple and easy pressure control solution.

An alternative solution could be obtained by application of overpressure at the inlets, or by a combination of both an overpressure at the inlets and a vacuum at the outlet. Although the same pressure is generally applied at both inlet ports, the concept of the invention could be applied with slight pressure difference, as long as the flow condition of the non analysis phase is respected, for having the intersection stream of FIG. 1b.

In the preferred embodiment, both analyte column 3 and by-pass channel 4 are linked at the outlet port 8, which guaranties a common outlet pressure.

Alternatively, both channels could be fully separated, with a different exit pressure control, as soon as the flow resistance of the second channel 4 (the by-pass) remains lower than the flow resistance of first channel 3, in the standby phase.

Finally, it appears that several parameters could be changed from the preferred above described embodiments, like tubes diameters and length, pressures, fluid speed, etc, without departing from the spirit of the invention. A lot of possible implementations are in fact possible, like combination of previous embodiments, leading to the intersection stream effect of FIG. 1b for standby phase and to the sample plug creation of FIGS. 2 to 4 for analysis phase, and based on continuous stream from inlets 1 and 2. The common thread in all embodiments of the present invention is the flow separation at the injection cross of FIG. 1b for the run phase and sample plug creation of FIGS. 2 to 4 for injection phase, with the introduction of continuous streams from inlets 1 and 2.

Devices according to the present invention can be practiced in various ways. Two examples are described presently.

In one application, the invention would serve as the basis of a continuous liquid stream sampling and injection component for miniaturized on-line liquid chromatography employed in process chemical analysis. The analyte is flowed through the bypass channel and is subsequently sampled and injected into the analytical channel according to the process described above. In this instance, the analytical channel serves as a chromatographic separation column.

In a second application of the invention, a microfluidic device can also be realized for miniaturized flow injection analysis, wherein the invention can serve as a continuous on-line analyte stream sampling system. In this configuration, channel 3 can be a reaction channel or a mixing channel for chemical reactions giving rise to products detectable by optical or electrochemical means for quantitative analysis of the analyte.

Even if the solution is particularly adapted for on line measurement, it is convenient for other measurements like with manual or automatic pipetting of inlet fluids.

Finally, the invention presents the following advantages. Because it is based on continuous streams of both fluids without any dead volumes, it is adapted for on line analysis. The continuous flow of analyte solution provides continuous refreshment of the sample line without periodic purging that would be normally necessary to ensure representative sampling before each analytical run, if analyte were to be injected onto the chip periodically, typically by a syringe pump. The same could be said for the carrier fluid line, thus obviating the need for complex external plumbing to maintain operation of the chip for continuous sampling. Because there is no necessity for external valves or inlet pumps, it is easy and inexpensive to implement. Simple and stable global pressure control is possible. This has a positive effect for the simplification of the whole device and process and for the reliability of the device. Sample plug reproducibility is facilitated, thus permitting the use of a reliable microfluidic system for chromatographic or flow injection analysis. Flow analysis systems based on the invention would be relatively inexpensive and easy to manufacture.

The invention now having been fully described, it will be apparent to one of ordinary skill in the art that changes and modifications, namely in the microfluidic architecture, and in the manner of plug generation, can be made thereto without departing from the spirit or scope of the appended claims.

We claim:

1. A method for providing flow injection in a microfluidic device, comprising the steps of:
(a) introducing a sample liquid stream to a first inlet channel and a carrier liquid stream into a second inlet channel, both of the inlet channels being connected respectively at one end to a microfluidic junction, the microfluidic junction having a low-resistance bypass outlet channel and a higher-resistance analytical outlet channel;
(b) balancing stream hydrostatic pressures allowing the sample liquid stream in the first inlet channel and the carrier liquid stream in the second inlet channel to converge at the junction forming a laminar confluence whereby streamlines of each flow cannot cross and therefore no mixing or exchange of fluid elements occurs at the junction where the sample stream is forced to spontaneously flow substantially into the low resistance bypass outlet channel and is blocked access to the higher-resistance outlet channel by the carrier stream which is forced to flow substantially into the higher-resistance analytical outlet channel, both the low-resistance bypass and higher-resistance analytical outlet channels being connected respectively at one end to the microfluidic junction;
(c) momentarily causing an imbalance in the respective flow rates of the sample and carrier liquid streams, whereby a portion of the sample liquid stream to is allowed to momentarily overflow into the higher-resistance analytical outlet channel;
(d) after said step of momentarily causing an imbalance, restoring initial inlet stream flow conditions thereby reestablishing flow of only the carrier liquid stream in the higher-resistance analytical outlet channel, whereby the sample portion in the higher-resistance analytical outlet channel is trapped and separated from the sample liquid stream by the carrier liquid stream; and
(e) transporting the sample portion in the higher-resistance analytical outlet channel by the carrier liquid stream, thereby forming a sample plug.

2. A method according to claim 1, wherein said step of momentarily causing an imbalance in the respective flow rates of the sample and carrier liquid streams includes momentarily reducing the hydrostatic pressure of the carrier liquid stream.

3. A method according to claim 1, wherein said step of momentarily causing an imbalance in the respective flow rates of the sample and carrier liquid streams includes pulsing the hydrostatic pressure of the sample liquid stream.

4. A method according to claim 1, wherein said step of momentarily causing an imbalance in the respective flow rates of the sample and carrier liquid streams includes formation of a bubble in the low-resistance bypass outlet channel, causing a momentary blockage and overflow of sample liquid stream into the higher-resistance analytical outlet channel.

5. A method according to claim 1, wherein said step of momentarily causing an imbalance in the respective flow rates of said inlet streams includes restricting the flow of sample liquid stream by momentarily creating a flow restriction within the low-resistance bypass outlet channel or externally to the low-resistance bypass outlet channel by the use of one or more valves.

6. A method for flow analysis comprising the following steps:
providing a carrier fluid stream through a first inlet means and a first inlet channel;
providing an analyte fluid stream through a second inlet means and a second inlet channel; and
creating a sample plug of analytical fluid, orienting said plug in an analytical channel and analyzing said plug through a detector cell of analytical channel in an analysis phase;
the two fluid streams being provided continuously by inlet means; and
the process further comprising the following steps:
causing the analyte fluid stream and the carrier fluid steam to meet at an injection cross of the inlet channels;
fully orienting the analyte fluid to a second channel in a non analysis phase;
creating the sample plug of analyte fluid by momentarily modifying of the flow conditions in at least one of the channels by a means in order to deviate a sample plug of analyte fluid in the analytical channel; and
rejoining the streams at outlet means of both analytical channel and second channel, both channels being connected and the second channel being a bypass channel of shorter length than the analytical channel length in order to present a lower flow resistance.

7. A method according to claim 6, further comprising the following steps:
providing the carrier fluid stream through a first inlet means and the analyte fluid stream through the second inlet means at around atmospheric pressure, forming continuous fluid streams; and
applying a vacuum at the outlet means of the analytical channel and at the outlet of the second channel for providing sub-atmospheric pressure.
